(19) United States
(12) Patent Application Publication
(10) Pub. No.: US 2013/0333497 A1
(43) Pub. Date: Dec. 19, 2013

(54) TRANSMISSION DEVICE

(71) Applicant: HON HAI PRECISION INDUSTRY CO., LTD., New Taipei (TW)

(72) Inventor: LIANG-CHING SU, New Taipei (TW)

(73) Assignee: HON HAI PRECISION INDUSTRY CO., LTD., New Taipei (TW)

(21) Appl. No.: 13/792,212

(22) Filed: Mar. 11, 2013

(30) Foreign Application Priority Data
Jun. 14, 2012 (TW) 101121417

(51) Int. Cl. F16H 19/06

(52) U.S. Cl. CPC F16H 19/06
USPC 74/89.22

(57) ABSTRACT

A transmission device includes a bracket, a belt, a driven module, and a limiting member. The bracket includes a mounting plate and a limiting piece extending from the mounting plate. The idle module is slidably mounted to the mounting plate. The belt is engaged with the idle module and preventing the idle module from sliding along a first direction relative to the mounting plate. The limiting member is located in a side of the idle module and rotatably mounted to the limiting piece. The limiting member abuts the idle module along the first direction, to prevent the idle module from sliding along a second direction, which is opposite to the first direction.

### BACKGROUND

1. Technical Field

The present disclosure relates to transmission devices, and particularly to a transmission device for a sprayer in an inkjet printer.

2. Description of Related Art

A sprayer in an inkjet printer, for printing, is slidably attached to a sliding pole. The sprayer is slid by a transmission device, which includes a belt, a motor, and an idle module. The motor is engaged with an end of the belt for supplying power source to the belt. The idle module is engaged with the other end of the belt and secured to a bracket by screws. The sprayer is secured to the belt and slid along the sliding pole with the belt. The tension of the belt can be adjusted by adjusting a distance between the idle module and the motor through sliding the driving module. However, the screws are easily loosened which affects the tension of the idle wheel. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a transmission device.

FIG. 2 is similar to FIG. 1, but viewed from a different aspect.

FIG. 3 is an assembled, isometric view of the transmission device of FIG. 1, but without a belt.

FIG. 4 is an assembled, isometric view of the transmission device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

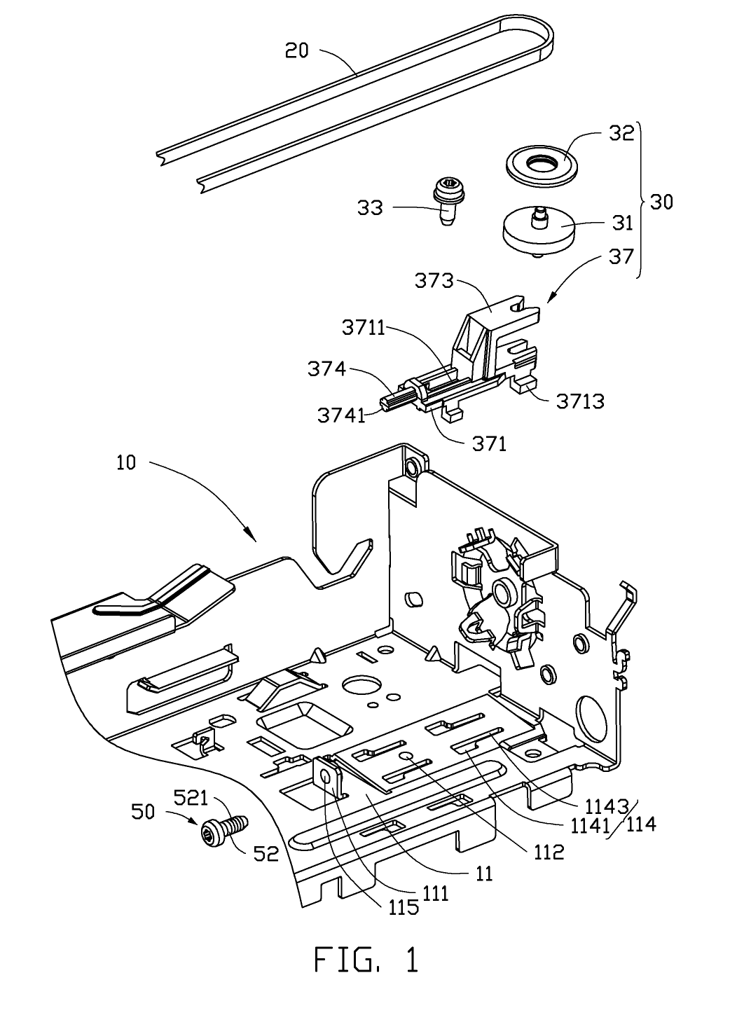

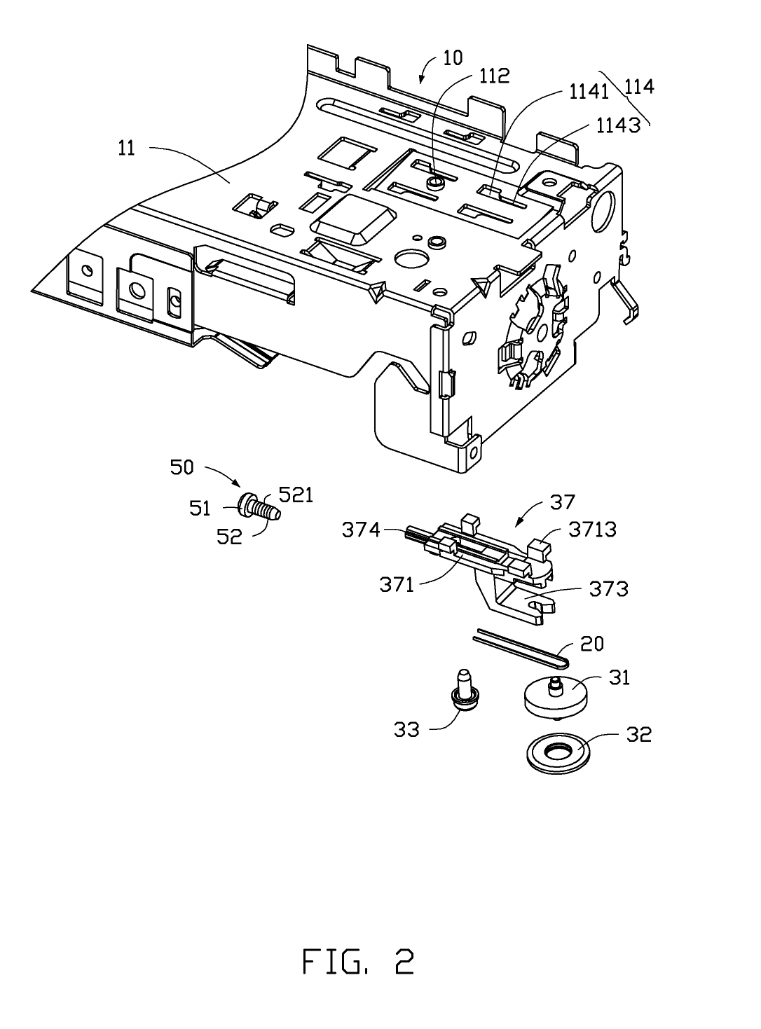

FIG. 1 and FIG. 2 show a transmission device in accordance with an embodiment. The transmission device includes a bracket 10, a belt 20, an idle module 30, and a limiting member 50.

The bracket 10 includes a mounting plate 11 and a limiting piece 111 extending from the mounting plate 11. The mounting plate 11 defines a mounting hole 112 and four sliding slots 114. The four sliding slots 114 are arranged in a rectangular pattern. The limiting piece 111 defines a locking hole 115 with inner threads. The locking hole 115 is used for locking the limiting member 50. Each sliding slot 114 includes an inserting portion 1141 and a sliding portion 1143. In one embodiment, the limiting piece 111 is substantially perpendicular to the mounting plate 11.

The driving module 30 includes an idle wheel 31, a washer 32, and a base 37 for securing the idle wheel 31. The base 37 is slidable relative to the mounting plate 11 and includes an installation plate 371 with a securing plate 373 connected to the installation plate 371. The installation plate 371 defines a horizontal hole 3711. Four latching blocks 3713 extend downwards from the mounting plate 11 corresponding to the four sliding slots 114. An extension arm 374 extends from the installation plate 371 away from the securing plate 373. The extension arm 374 includes a side surface 3741. The side surface 3741 is substantially perpendicular to the installation plate 371. The idle wheel 31 and the washer 32 are secured between the securing plate 373 and the installation plate 371. In one embodiment, the four latching blocks 3713 are arranged in a rectangular pattern.

The limiting member 50 includes a limiting portion 51 and a threaded portion 52. A cross-section of the limiting portion 51 and the threaded portion 52 is circular. A diameter of the limiting portion 51 is greater than a diameter of the threaded portion 52. The threaded portion 52 includes a plurality of outer threads 521 corresponding to the inner threads of the locking hole 115. In one embodiment, the limiting member 50 is a screw.

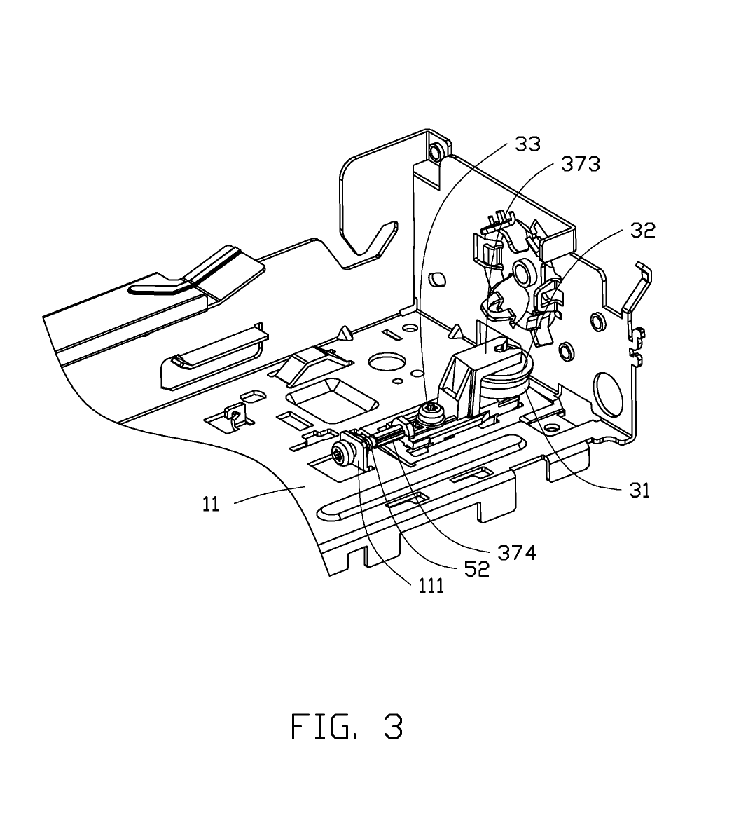

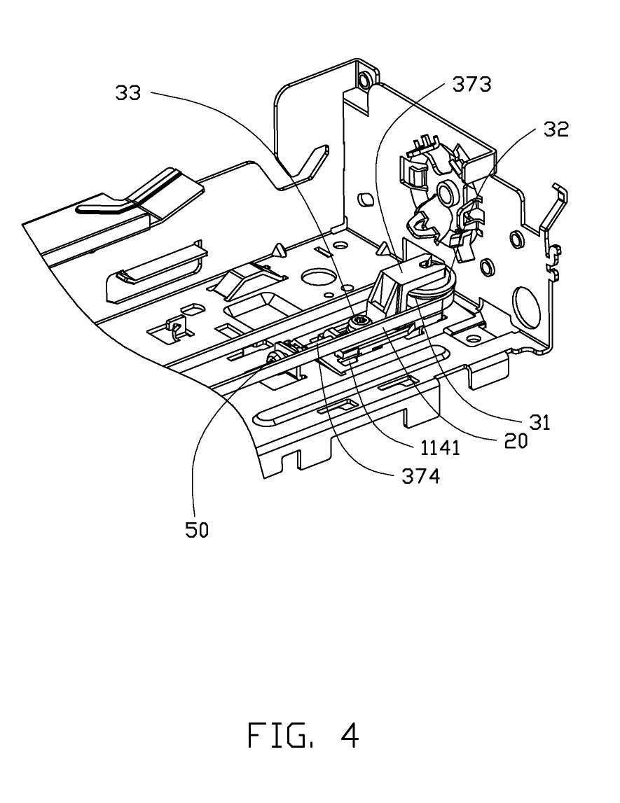

FIG. 3 and FIG. 4 show that in assembly, the four latching blocks 3713 are engaged with the sliding portions 1143 through the inserting portions 1141, so that the base 37 is slidably attached to the mounting plate 11. The idle wheel 31 is positioned between the securing plate 373 and the installation plate 371, the securing plate 373 abuts a first surface of the washer 32, and the idle wheel 31 abuts a second surface of the washer 32. The mounting hole 112 is aligned with the horizontal hole 3711. The extension arm 374 is opposite to the limiting piece 111 and aligned with the locking hole 115. The belt 20 is engaged with the idle wheel 31 and a motor (not shown). Thus, the idle module 30 slidably mounted to the mounting plate 11. An extending direction of the extension arm 374 is substantially perpendicular to the limiting piece 111. The threaded portion 52 is threaded into the locking hole 115 until an end of the threaded portion 52 abuts the side surface 3741.

In use, the idle module 30 is slid along a first direction until the tension of the belt 20 is equal to a preset value. A locking member 33 is locked into the mounting hole 112 through the horizontal hole 3711, to prevent the idle module 30 from sliding relative to the mounting plate 11. In this position, if the locking member 33 is loosened, the idle module 30 will slide along a second direction, opposite to the first direction, relative to the mounting plate 11 to affect the tension of the belt 20. The threaded portion 52 is threaded in the locking hole 115 until an end of the threaded portion 52 abuts the side surface 3741 along the first direction. Thus, the limiting member 50 blocks the idle module 30 to slide along the second direction when the locking member 33 is loosened.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A transmission device comprising:
a bracket comprising a mounting plate and a limiting piece extending from the mounting plate;
an idle module slidably mounted to the mounting plate;
a belt engaged with the idle module and preventing the idle module from sliding along a first direction relative to the mounting plate; and
a limiting member located in a side of the idle module and rotatably mounted to the limiting piece;
wherein the limiting member abuts the idle module along the first direction, to prevent the idle module from sliding along a second direction, which is opposite to the first direction.

2. The transmission device of claim 1, wherein the idle module comprises a base, an idle wheel secured to a first side of the base, and an extension arm extending from a second side of the base, and the limiting member abuts the extension arm.

3. The transmission device of claim 2, wherein the extension arm comprises a side surface, the side surface is substantially perpendicular to the mounting plate, and the limiting member abuts the side surface.

4. The transmission device of claim 3, wherein the limiting piece defines a locking hole with inner threads, and the limiting member comprises threaded portions having outer threads corresponding to the inner threads.

5. The transmission device of claim 4, wherein the threaded portion is rotatably mounted in the locking hole, and an end of the threaded portion abuts the side surface.

6. The transmission device of claim 2, wherein the base comprises an installation plate and a securing plate connected to the installation plate, and the idle wheel is secured between the installation plate and the securing plate.

7. The transmission device of claim 6, further comprising a locking member, wherein the installation plate defines a horizontal hole, the mounting plate defines a mounting hole, and the locking member is secured to the mounting hole through the horizontal hole.

8. The transmission device of claim 6, wherein the mounting plate further defines at least one sliding slot, each sliding slot comprises an inserting portion and a sliding portion, the base further comprises at least one latching block extending from the base, and the at least one latching block is slidably engaged in the sliding portion through the inserting portion.

9. The transmission device of claim 8, wherein the at least one sliding slot comprises four sliding slots arranged in a rectangular pattern, and the at least one latching block comprises four latching blocks arranged in a rectangular pattern.

10. The transmission device of claim 1, wherein the limiting member is a screw.

11. A transmission device, comprising:
a bracket comprising mounting plate and a limiting piece extending from the mounting plate, the mounting plate defining a mounting hole;
an idle module slidably mounted to the mounting plate along a first direction and defining a horizontal hole;
a locking member engaged in the mounting hole through the horizontal hole, to secure the idle module to the mounting plate;
a belt engaged with the idle module; and
a limiting member located in a side of the idle module and rotatably mounted to the limiting piece;
wherein the limiting member abuts the idle module along the first direction, to prevent the idle module from sliding along a second direction, which is opposite to the first direction, when the locking member is loosened.

12. The transmission device of claim 11, wherein the idle module comprises a base, an idle wheel secured to a first side of the base, and an extension arm extending from a second side of the base, and the limiting member abuts the extension arm.

13. The transmission device of claim 12, wherein the extension arm comprises a side surface, the side surface is substantially perpendicular to the mounting plate, and the limiting member abuts the side surface.

14. The transmission device of claim 13, wherein the limiting piece defines a locking hole with inner threads, and the limiting member comprises threaded portions having outer threads corresponding to the inner threads.

15. The transmission device of claim 14, wherein the threaded portion is rotatably mounted in the locking hole, and an end of the threaded portion abuts the side surface.

16. The transmission device of claim 12, wherein the base comprises an installation plate and a securing plate connected to the installation plate, and the idle wheel is secured between the installation plate and the securing plate.

17. The transmission device of claim 16, wherein a horizontal hole is defined in the installation plate.

18. The transmission device of claim 16, wherein the mounting plate further defines at least one sliding slot, each sliding slot comprises an inserting portion and a sliding portion, the base further comprises at least one latching block extending from the base, and the at least one latching block is slidably engaged in the sliding portion through the inserting portion.

19. The transmission device of claim 18, wherein the at least one sliding slot comprises four sliding slots arranged in a rectangular pattern, and the at least one latching block comprises four latching blocks arranged in a rectangular pattern.

20. The transmission device of claim 11, wherein the limiting member is a screw.
